(19) United States
(12) Patent Application Publication
(10) Pub. No.: US 2016/0253219 A1
(43) Pub. Date: Sep. 1, 2016

(54) DATA STREAM PROCESSING BASED ON A BOUNDARY PARAMETER

(71) Applicant: HEWLETT PACKARD ENTERPRISE DEVELOPMENT LP, Houston, TX (US)

(72) Inventors: Qiming Chen, Cupertino, CA (US); Meichun Hsu, Los Altos Hills, CA (US); Maria G. Castellanos, Sunnyvale, CA (US)

(21) Appl. No.: 15/032,884

(22) PCT Filed: Dec. 13, 2013
(86) PCT No.: PCT/US2013/075016

§ 371 Date: Apr. 28, 2016

(51) Int. Cl. G06F 9/52

(52) U.S. Cl. CPC G06F 9/52

(57) ABSTRACT

In one implementation, a system for processing a data stream can comprise a station engine, an execution engine, and a synchronize engine. A station engine can provide a stream operator to receive application logic, punctuate the data stream, and determine a number of input channels for parallel processing. The execution engine can perform a behavior of the application logic during a process operation. The synchronize engine can hold data of the data stream associated with a window until each input channel has reached a data boundary based on a boundary parameter.

### BACKGROUND

A computer can have a processor, or be part of a network of computers, capable of processing data and/or instructions in parallel. Concurrent computations can be beneficial in the context of data stream analytics. For example, a data stream can be analyzed where the data volume is large and the computations to analyze the data are expensive in terms of compute resources. Data analysis can be performed using a sliding window technique. Sliding window computations can be time restrictive.

### BRIEF DESCRIPTION OF THE DRAWINGS

FIGS. 1 and 2 are block diagrams depicting example systems for processing a data stream.

FIG. 3 depicts example environments in which various example systems for processing a data stream can be implemented.

FIG. 4 depicts example modules used to implement example systems for processing a data stream.

FIG. 5 depicts example operations for processing a data stream.

FIGS. 6-8 are flow diagrams depicting example methods for processing a data stream.

### DETAILED DESCRIPTION

In the following description and figures, some example implementations of systems and/or methods for processing a data stream are described. A data stream can include a sequence of digitally encoded signals. The data stream can be part of a transmission, an electronic file, or any combination of transmissions and files. For example, a data stream can be a sequence of data packets or a word document containing strings or characters, such as a deoxyribonucleic acid (“DNA”) sequence. A data stream can be processed by performing a series of operations on portions of a set of data from the data stream. Stream processing commonly deals with sequential pattern analysis and can be sensitive to order and/or history associated with the data stream. Stream processing with such sensitivities can be difficult to parallelize.

A sliding window technique of stream processing can designate a portion of the set of data of the data stream as a window and can perform an operation on the window of data as the boundaries of the window move along the data stream. The window can “slide” along the data stream to cover a second set of boundaries of the data stream, and, thereby, cover a second set of data. Sequential slides can have overlapping portions of the data stream. In stream processing, an analysis operation can be performed on each window of the data stream. For example, sequential pattern analysis can be performed on each portion of data as the slide boundaries moves along the data stream. Many stream processing applications based on a sliding window technique can utilize sequential pattern analysis and can perform history-sensitive analytical operations. For example, an operation on a window of data can depend on a result of an operation of a previous window. Due to the timing restrictions, the complexities of operating sliding window processing in parallel include data boundary determinations, buffering and sliding stepwise intermediate results, and synchronizing the punctuation of multiple data streams.

Various examples described below relate to processing a data stream based on a boundary parameter. By using a template behavior that accepts application logic (including boundary parameters and operation details), data and operations can be synchronized to apply stream analytics in a concurrent environment. Boundary parameters are a set of data used to determine the data grouping boundaries. In general, the system can resolve a tuple over all input channels, and, if the tuple belongs to the current boundary (e.g. granule, slide, or window), the tuple can be processed, otherwise the tuple is held to be processed later. As used herein, the term “resolve” and variations thereof, means to verify each input channel has received a designated portion of the data stream. Multiple parallel input channels can be synchronized, or otherwise resolved, based on punctuation. For example, assume a task has three input channels and is currently working on a first window. After a stream operator receives a tuple belonging to a second window the task of stream operator may not be able to conclude processing the first window depending on whether all the input channels have finished supplying the tuples belonging to the first window and started to supply tuples belonging to the second window. If the window processing is concluded before each input channel has received data from a following window, the processing on the first window can yield inaccurate results.

The boundary parameters can include data to set data grouping boundaries, including a granule, a slide, and a window. A granule is a basic unit of grouping data, such as a chunk of any number of tuples or a set of tuples with timestamps falling in a specified time range. As used herein, a tuple is a data record transferred between tasks to perform sliding window operations. A slide is any number or range of granules. For example, a slide of ten minutes can be composed of ten granules where each granule defines one minute. A window can also be any number or range of granules, but the window, as used herein, is at least the size of the slide.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based only on the stimulus or a combination of stimuli including the stimulus.

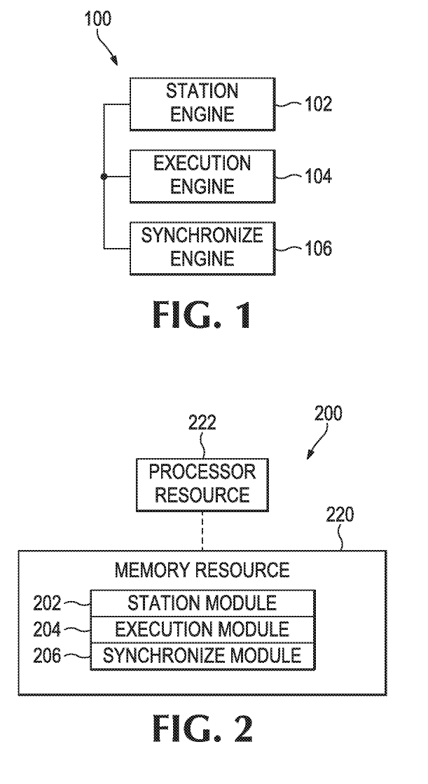

FIGS. 1 and 2 are block diagrams depicting example systems for processing a data stream. Referring to FIG. 1, an example system for processing a data stream generally comprises a station engine 102, an execution engine 104, and a synchronize engine 106.

The station engine 102 represents any combination of circuitry and executable instructions configured to provide a stream operator. The stream operator can be a general stream operator to receive a data stream for processing and may have common properties and operations without regard to the specific method of processing. The general stream operator can be executed to perform operations of a specific stream operator based on analysis-specific operations. The stream operator can invoke a skeleton function to be implemented by users based on application logic. In this way, the station engine 102 can provide support for the stream operator while allowing for the analysis-specific application logic to be plugged in.

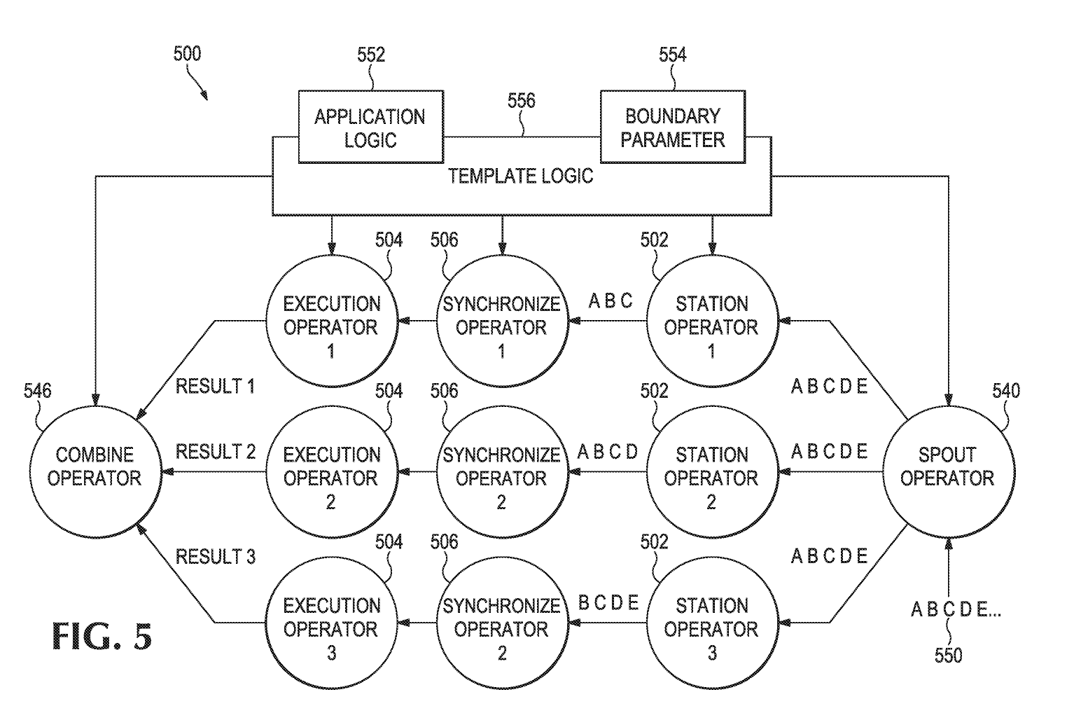

The stream operator can receive application logic for sliding window processing. The application logic is input provided from a user to specify operation details of the stream operator. The application input can include boundary parameters and executable instructions to specify processing details for the sliding window semantics, also referred to herein as “dynamic behavior.” The station engine 102 can contain template logic. Template logic represents a set of instructions to synchronize, initialize, and otherwise organize the data stream and operations to provide stream processing. For example, the template logic can contain instructions to synchronize the data stream in parallel over a number of execution engines, such as shown in FIG. 5 and explained in more detail below. The template logic can represent the common properties among parallel sliding window operations and the template logic may be structured to allow for stream processing details regarding the data stream and the processing operations. For example, the station engine 102 can receive the application logic to specify processing details of a template logic to a particular pattern analysis operation and the grouping level at which the operation should take place. The template behavior of the stream operator can depend on properties to describe the operation pattern of the system 100.

The stream operator can punctuate the data stream based on a boundary parameter. As used herein, “punctuate,” or variation thereof, means to associate a set of data with a data group boundary. Punctuation can occur by maintaining a field or property associated with a data tuple or by calculating the associated data group boundary based on the properties of a data tuple. For example, all tuples of the data stream can be labeled consecutively starting with the number one and the system 100 can calculate that data tuples one to ten are associated with the first granule, and tuples eleven to twenty are associated with the second granule, and so forth. By reasoning the data group boundaries based on tracking the tuples of the data stream, the data group boundaries can be “punctuated” on the data stream without the use of a punctuator module to alter the data stream. The boundary parameters are the boundary definitions provided by a user to determine data group boundaries of the data stream. For example, the user can select a granule size of five tuples, a slide size of two minutes, and a window size of ten minutes.

A plurality of boundary parameters can include a granule size, a slide size, and a window size. A granule size can be a range (or number) of tuples. A slide size can be a first range (or number) of granules and a window size can be a second range (or number) of granules. The first range of granules and second range of granules can be the same.

The station engine 102 can determine a number of input channels for parallel processing by the stream operator. The input channels are the number of flows of the data stream to operators to perform the processing in parallel.

The execution engine 104 represents any combination of circuitry and executable instructions configured to perform a behavior of the application logic during a process operation. The execution engine 104 can process a tuple based on the application logic and the punctuation of the tuple. For example, if a slide or window boundary is reached, the slide or window based processing can be performed. If the tuple is part of group to be processed where the entire group has not been received, the tuple can be held, as discussed in more detail in the description of the synchronize engine 106.

The execution engine 104 can perform a behavior of the application logic based on a boundary parameter. For example, the application can specify what operations to perform at each boundary level or even not to perform operations at a boundary level, such as the granule level. The execution engine 104 can execute a template behavior and a dynamic behavior. For example, the execution engine 104 can execute a template behavior to initialize parallel processing of the data stream. The execution engine 104 can execute a dynamic behavior based on a boundary parameter and application logic for sliding window processing. For example, the execution engine 104 can process a tuple associated with a first window based on the application logic when a boundary of a second window is achieved. The execution engine 104 can apply a dynamic behavior based on the tuples held by the synchronize engine 106. For example, if a set of held tuples achieves a slide boundary and a window boundary, a window can be processed. The dynamic behavior can also be applied to partial processing based on the application logic. For example, the application logic can allow for a first window to be partially processed based on a set of held tuples that is less than a window size, in particular, based on the punctuation of the set of held tuples. The execution engine 104 can process the set of tuples by summarizing the data based on the application logic. For example, the dynamic behavior can include summarizing one of a window, a slide, and a granule in accordance with the application logic based on the data boundary reached at each parallel execution.

The execution engine 104 can resolve a granule across input channels. For example, the execution engine 104 can determine when a granule has streamed through each input channel and is available for processing. The execution engine 104 can track held granules and resolved granules to synchronize analysis of the data stream. For example, a granule field can be kept to track granules through the system 100.

The synchronize engine 106 represents any combination of circuitry and executable instructions configured to hold data of the data stream associated with a window until each input channel has reached a data boundary based on the boundary parameter. For example, the synchronize engine 106 can hold onto data tuples until the current tuple achieves the data boundary identified from the boundary parameter received from the user with the application logic. In general, the synchronize engine 106 assists the system 100 to maintain the state of the data stream and/or system 100 until sufficient data is received among the input channels to be processed by the execution engine 104. The synchronize engine 106 can hold a tuple of the data stream when a granule number of the current input is larger than a resolved granule number. Tuples can be held based on the rate of processing. For example, a tuple can be held when a slide operation does not advance or when a current input is larger than a resolved input.

FIG. 2 depicts system 200 for processing a data stream can be implemented on a memory resource 220 operatively coupled to a processor resource 222. Referring to FIG. 2, the memory resource 220 can contain a set of instructions that can be executable by the processor resource 222. The set of instructions can implement the system 200 when executed by the processor resource 222. The set of instructions stored on the memory resource 220 can be represented as a station module 202, an execution module 204, and a synchronize module 206. The processor resource 222 can carry out the set of instructions to execute the station module 202, the execution module 204, the synchronize module 206, and/or any appropriate operations among or associated with the modules of the system 200. For example, the processor resource 222 can carry out a set of instructions to execute a template behavior to initialize parallel processing of a data stream, execute a dynamic behavior based on a boundary parameter and application logic for sliding window processing, hold a tuples of the data stream when a granule number of the current input is larger than a resolved granule input, and process the held tuple of a first window based on the application logic when the second window boundary is achieved. The station module 202, the execution module 204, and the synchronize module 206 represent program instructions that when executed function as the station engine 102, the execution engine 104, and the synchronize engine 106 of FIG. 1, respectively.

The processor resource 222 can be one or multiple CPUs capable of retrieving instructions from the memory resource 220 and executing those instructions. The processor resource 222 can process the instructions serially, concurrently, or in partial concurrence, unless described otherwise herein.

The memory resource 220 represents a medium to store data utilized by the system 200. The medium can be any non-transitory medium or combination of non-transitory mediums able to electronically store data and/or capable of storing the modules of the system 200 and/or data used by the system 200. For example, the medium can be a storage medium, which is distinct from a transmission medium, such as a signal. The medium can be machine readable, such as computer readable.

In the discussion herein, the engines 102, 104, and 106 of FIG. 1 and the modules 202, 204, and 206 of FIG. 2 have been described as a combination of circuitry and executable instructions. Such components can be implemented in a number of fashions. Looking at FIG. 2, the executable instructions can be processor executable instructions, such as program instructions, stored on the memory resource 220, which is a tangible, non-transitory computer readable storage medium, and the circuitry can be electronic circuitry, such as processor resource 222, for executing those instructions. The processor resource 222, for example, can include one or multiple processors. Such multiple processors can be integrated in a single device or distributed across devices. The memory resource 220 can be said to store program instructions that when executed by the processor resource 222 implements the system 200 in FIG. 2. The memory resource 220 can be integrated in the same device as the processor resource 222 or it can be separate but accessible to that device and the processor resource 222. The memory resource 220 can be distributed across devices.

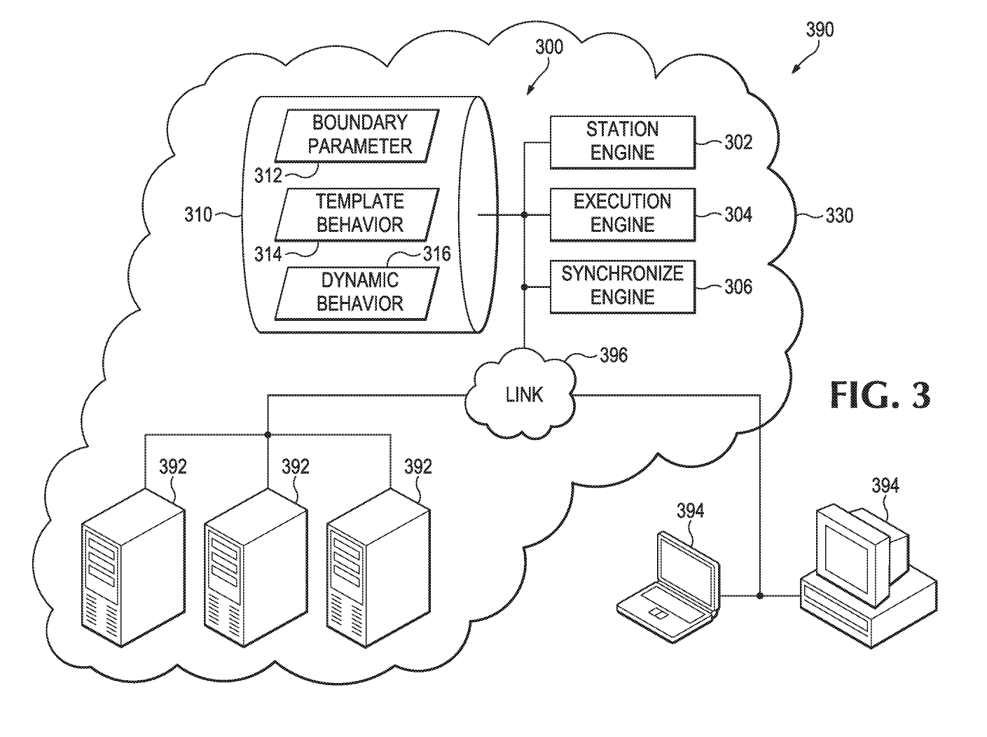

In one example, the executable instructions can be part of an installation package that when installed can be executed by processor resource 222 to implement the system 200. In that example, the memory resource 220 can be a portable medium such as a CD, a DVD, a flash drive, or memory maintained by a computer device, such as server device 392 of FIG. 3, from which the installation package can be downloaded and installed. In another example, the executable instructions can be part of an application or applications already installed. Here, the memory resource 220 can include integrated memory such as a hard drive, solid state drive, or the like

FIG. 3 depicts example environments in which various example systems for processing a data stream can be implemented. The example environment 390 is shown to include an example system 300 for processing a data stream. The system 300 (described herein with respect to FIGS. 1 and 2) can represent generally any combination of circuitry and executable instructions configured to process a data stream. The system 300 can include a station engine 302, an execution engine 304, and a synchronize engine 306 that are the same as the station engine 102, the execution engine 104, and the synchronize engine 106 of FIG. 1, respectively, and, for brevity, the associated descriptions are not repeated.

The example system 300 can be integrated into a server device 392 or a client device 394. The system 300 can be distributed across server devices 392, client devices 394, or a combination of server devices 392 and client devices 394. The environment 390 can include a cloud computing environment, such as cloud network 330. For example, any appropriate combination of the system 300, server devices 392, and client devices 394 can be a virtual instance and/or can reside and/or execute on a virtual shared pool of resources described as a “cloud.” The cloud network 330 can include any number of clouds.

In the example of FIG. 3, a client device 394 can access a server device 392. The server devices 392 represent generally any computing devices configured to respond to a network request received from the client device 394. For example, a server device 392 can be a virtual machine of the cloud network 330 providing a service and the client device 394 can be a computing device configured to access the cloud network 330 and receive and/or communicate with the service. A server device 392 can include a webserver, an application server, or a data server, for example. The client devices 394 represent generally any computing devices configured with a browser or other application to communicate such requests and receive and/or process the corresponding responses. A link 396 represents generally one or any combination of a cable, wireless, fiber optic, or remote connections via a telecommunications link, an infrared link, a radio frequency link or any other connectors of systems that provide electronic communication. The link 396 can include, at least in part, intranet, the Internet, or a combination of both. The link 396 can also include intermediate proxies, routers, switches, load balancers, and the like.

The data associated with the system 300 can be stored in a data store 310. For example, the data store 310 can store the boundary parameter(s) 312, a template behavior 314, and a dynamic behavior 316. The data store 310 can be accessible by the engines 302, 304, and 306 to maintain data associated with the system 300.

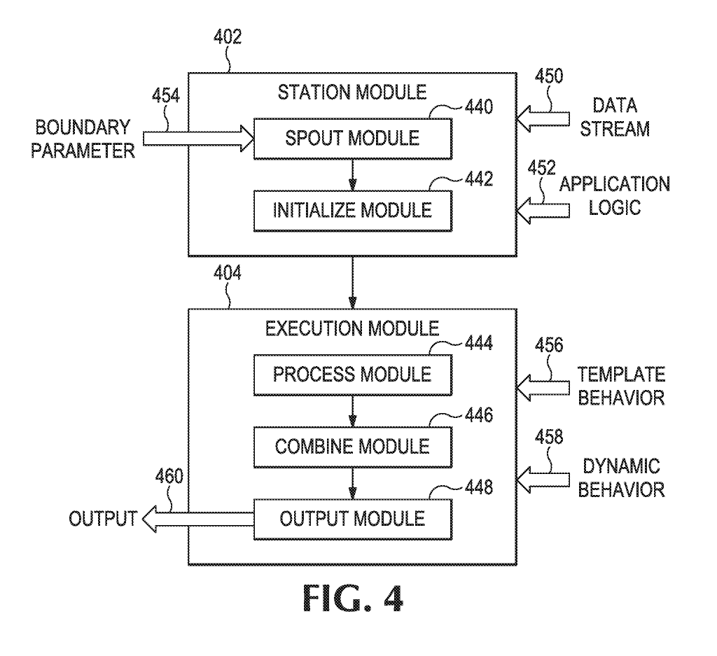

FIG. 4 depicts example modules used to implement example systems for processing a data stream 450. The example modules of FIG. 4 generally include a station module 402 and an execution module 404, which can be the same as the station module 202 and the execution module 204 of FIG. 2. As depicted in FIG. 4, the example modules can also include a spout module 440, an initialize module 442, a process module 444, a combine module 446, and an output module 448.

The station module 402 can receive a data stream 450, a boundary parameter 454, and application logic 452. The station module 402 can prepare the system to process the data stream 450. For example, the station module 402 can prepare the data stream 450 and the stream operator via a spout module 440 and an initialize module 442.

The spout module 440 can generate tuples from the data stream 450. The spout module 440 can punctuate the tuples based on the boundary parameter 454. For example, the spout engine 440 can maintain a granule field for each tuple of the data stream 450. The spout module 440 can distribute the data stream 450 to the input channels.

The initialize module 442 can use the boundary parameter 454 and the application logic 452 to prepare the system for operation. For example, the initialize module 442 can use the boundary parameter 454 to determine how the data stream 450 can be modified by the spout module 440. For another example, the initialize module 442 can determine the topology for processing, such as the number of input channels to be used. The initialize module 442 can preprocess the input data on a per tuple basis, such as filtering and sorting. The initialize module 442 can set, based on the boundary parameter 454 received, a granule size to be a range of tuples, a slide size to be a number of granules, and a window size to be a number of granules.

The initialize module 442 can initiate the stream operator to receive a data stream 450 for processing. An open stream operator can be stationed to receive a flow of the data stream 450. The initialize module 442 can execute the stream operator to have properties associated with template logic 456 that is common among parallel sliding window semantics and dynamic behavior 458 specified by the application logic 452. The stream operator can be formed based on a hierarchy where each class of stream operator can provide operations based on the execution module 404 and associated support functions. For example, in object oriented programming, the execution module 404 can be coded to invoke skeleton functions to be implemented based on the application logic 452 as to have designated system support for insertable dynamic behavior 458.

The execution engine 404 can maintain operations of the stream operator based on the application logic 452. The execution engine 404 can maintain the system to process the data stream 450 based on the boundary parameter 454, the template behavior 456, and the dynamic behavior 458. For example, the execution engine 404 can invoke the application logic 452 to process the data stream 450 based on a sliding window technique. The execution engine 404 can execute operations to process the data stream 450 via a process module 444, a combine module 446, and an output module 448.

The process module 444 can process the data stream 450 based on the template behavior 456 and the dynamic behavior 458. The process module 444 can mine, analyze, or otherwise process a tuple received from an input channel. For example, a set of tuples can be received that are associated with a window of the data stream 450, and the application logic 452 can determine that each window of data can be mined for a particular pattern.

The process module 444 can access the set of tuples held by a synchronize engine, such as synchronize engine 106 of FIG. 1. For example, a tuple can be held when the current input of an input channel is larger than a resolved input. The held tuples can be processed based the tuple at which the input channel is processing. For example, the process module 444 can receive input from one of a plurality of channels and the data stream 450 can be processed by the plurality of channels based on the application logic 452 when the punctuation boundary associated with the processing is achieved.

The combine module 446 can combine the output of the processing tasks based on the template behavior 456 and the dynamic behavior 458. For example, the application logic 452 can specify how the output from each processing task can be summarized or otherwise combined. The output module 448 can send out the combined data processing results. For example, the combined data processing results can be a pattern or set of patterns discovered in the data stream 450.

FIG. 5 depicts example operations for processing a data stream 550. In general, the operations can include distributing the data stream 550 across input channels to be processed and combining the results of the parallel processing. Three levels of concurrency are shown as an example in FIG. 5 and any number of parallel processing can be implemented using the systems and/or methods described herein.

The example operations can be determined based on template logic 556, a boundary parameter 554, and application logic 552. The template logic 556 can determine the common operations of the operators of the system 500 and the application logic 552 can determine the analysis-specific operations of the operators of the system 500. The operators of the system 500 can include a spout operator 540, a station operator 502, a synchronize operator 506, an execution operator 504, and a combine operator 546.

The template logic 556 can determine the operations for processing the data stream 550 once the template logic 556 receives a boundary parameter 554 to determine the size of data to operate on and application logic 552 to implement the specific processing details and operations on the sizes of data determined by the boundary parameter 554. For example, the template logic 554 can determine the operations of the spout operator 540 based on a granule size, a slide size, and a window size provided with the boundary parameters 554

The spout operator 540 can generate tuples with a granule field. The spout operator 540 can distribute the data stream 550 to the station operator 502 for each input channel. The synchronize operator 506, in conjunction with the spout operator 540, can maintain a granule table to contain a granule number of each input channel. The input tuples from each individual input channel are delivered in order by granule; however, the granule numbers may not be synchronized as delivered by the station operator 502. The station operator 502 can track the current granule number and the current window identifier. The current granule number can be compared to the last resolved granule processed by the execution operator 504. The comparison can determine to hold the set of tuples from the station operator 502 at a synchronize operator 506 until a punctuation boundary is achieved. For example, if the synchronize operator 506 is holding a set of tuples and the current granule received is from a second window, then the set of tuples associated with the first window can be sent to the execution operator 504 for processing.

The execution operator 504 can invoke the application logic 552 to process the data stream 550 based on the dynamic behavior of the sliding window technique. The execution operator 504 can receive the input from the input channel of the station operator 502 (via the synchronize operator 506) and be processed based on the application logic 552. For example, the execution operator 504 can process the set of tuples of the synchronize operator 506 associated with a first window based on the specific processing details associated with window-level processing from the application logic 552 when the boundary of the first window is achieved and the slide boundary is achieved. The application logic 552 can allow for partial processing of data. For example, the set of held tuples of the synchronize operator 506 can be less than a window size and a window can be partially process based on the set of held tuples. Partial processing can include processing at the slide level or the granule level.

With respect to each station operator 502, the current granule is determined. For example, if a first station operator 502 has received granules A through C, a second operator has received granules A through D, and a third station operator has received granules A through E, than the current granule is granule C. A granule table can be used to maintain the current granule number with respect to each of the input channels. For example, the granule table can be updated as new input is received and the minimal granule number changes based on monitoring each input channel. If the station operator 502 receives a granule that is large than the last resolved tuple, the tuple can be held without processing until an appropriate punctuation boundary is reached as determine by the application logic 552 and the boundary parameter 554. If the synchronize operator 506 is holding onto tuples associated with a first window and a second window when the current input resolves to a boundary of the second window, the execution operator 504 can retrieve the tuples associated with the first window and the synchronize operator 506 can continue to hold onto the tuples associated with the second window until the appropriate punctuation boundary is achieved.

The combine operator 546 can combine the output of the execution operators 504 based on the current input. For example, the combine operator 546 can combine a set of summaries associated with a first window based on the conclusion of the first window as determined by the granule table.

In general, the operators 540, 502, 504, 506, and 546 of FIG. 5 described above represent operations, processes, interactions, or other actions performed by or in connection with the engines 102, 104, and 106 of FIG. 1.

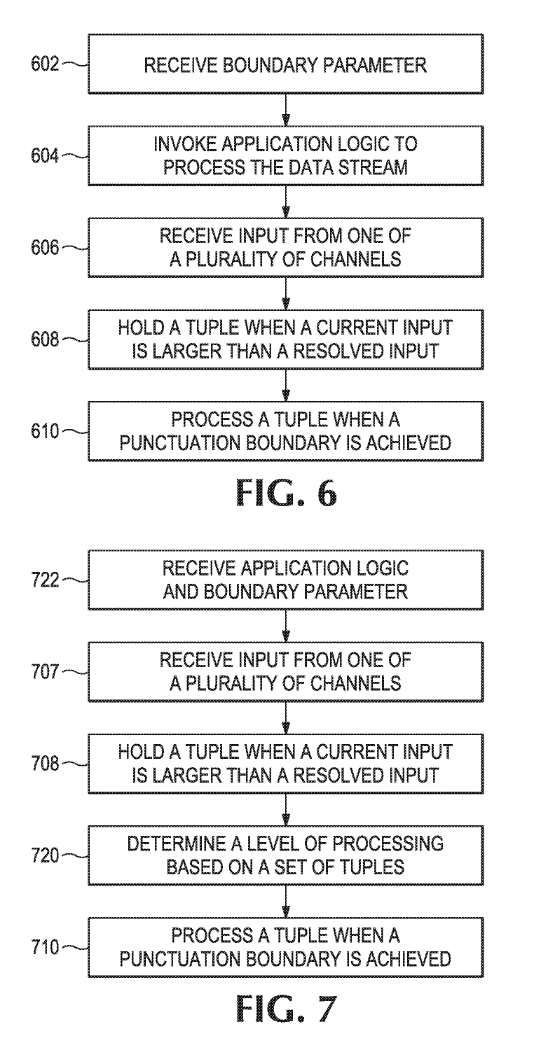

FIGS. 6-8 are flow diagrams depicting example methods for processing a data stream. Referring to FIG. 6, example methods for processing a data stream can generally comprise receiving a boundary parameter, invoking application logic to process the data stream, receive input form one of a plurality of channels, hold a tuple when a current input is larger than a resolved input, and processing a tuple when a punctuation boundary is achieved.

At block 602, a boundary parameter is received. The boundary parameter can be received with the application logic. The boundary parameters can be received from a user to determine the groups of data at which the data stream can be processed. For example, the boundary parameters can include a range or number of tuples to be a granule size, a range or number of granules to be a slide size, and a range or number of granules to be window size.

At block 604, application logic is invoked to process the data stream. The application logic can determine the analysis-specific properties of the stream operator for processing the data stream. For example, the application logic can contain functions to summarize a window in a specific way to determine a pattern. The application logic can be plugged into the general template logic to determine processing details. For example, a specific sliding window technique can be used to modify the general framework for processing a sliding window in parallel.

At block 606, input from one of a plurality of channels is received. The number of plurality of channels and the delivery of input from the plurality of channels can be based on the application logic. For example, the data stream can be delivered to each input channel based on a configuration selected by a user.

At block 608, a tuple is held when a current input is larger than a resolved input. The tuples should be synchronized across input channels during processing, and holding the tuples at each channel can allow for the tuple synchronization. In particular, input can be held at each channel until a complete group of data for processing is reached, such a range of tuples equal to a window. A tuple can be held until a punctuation boundary is achieved.

At block 610, a tuple is processed when a punctuation boundary is achieved. The tuple can be processed according to application logic. For example, the application logic can specify the processing of the data stream to summarize the set of held tuples using a first function when the set of tuples achieves the size of a granule and summarize the set of tuples using a second function when the set of tuples achieves the size of a window.

FIG. 7 includes blocks similar to the blocks of FIG. 6 and provides an additional block and details. In particular, FIG. 7 depicts an additional block and details generally regarding determining a level of processing based on a set of tuples. The blocks 722, 706, 708, and 710 are similar to blocks 602, 604, 606, 608, and 610, and, for brevity, the associated descriptions are not repeated.

At block 720, a level of processing is determined based on a set of tuples, the boundary parameter, and the application logic. The application logic can specify what level of processing is appropriate (e.g. granule level, slide level, or window level) and which dynamic behavior to perform at that level. The dynamic behavior of the application logic can be selected based on the boundary parameter determining what group of data the set of held tuples belongs to (e.g. a granule, a slide, or a window). For example, the application logic can specify a granule dynamic behavior, a slide dynamic behavior, and a window dynamic behavior, and the appropriate dynamic behavior can be performed on the associated level of grouped data.

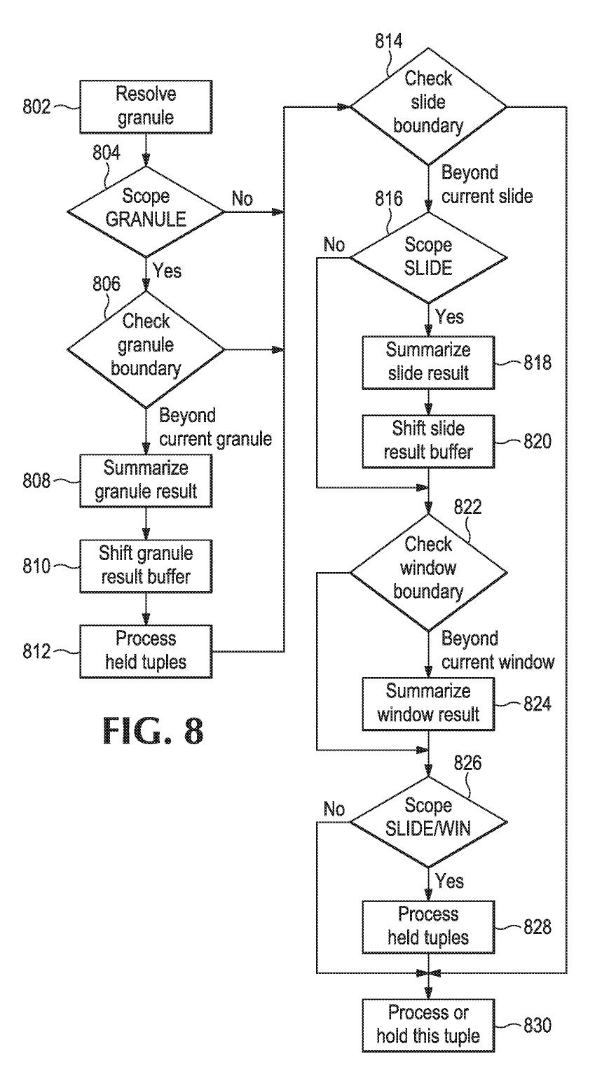

FIG. 8 includes blocks similar to the blocks of FIGS. 6 and 7 and provides additional blocks and details. In particular, FIG. 8 depicts additional blocks and details generally describing a framework for processing based on the boundary parameters. The application logic utilizes the processing framework to provide partial window processing when the set of held tuples is less than the window size. For example, the level of processing can be a slide summarization when the set of held tuples achieves a slide boundary and the level of processing can be a granule summarization when the set of held tuples achieves a granule boundary.

FIG. 8 shows blocks for processing portions of the data stream from three levels of granularity (e.g. the set of tuples can be equal to the granule size, the slide size, or the window size). The method can follow any appropriate set of blocks based on the set of tuples being held, the boundary parameters, and the application logic. The application logic can specify to only process at a determined level of processing at any given time. For example, if the set of tuples is held to process at a slide level for partial processing, the set of tuples may not be continued to be held to process a window level for complete processing; instead, the following tuples can be processed partially at a granule level until the window boundary is reached. In this way, the data can be synchronized for processing until the appropriate data boundary is reached and the stream operator can continue to process the data stream in parallel.

At block 802, a granule can be resolved. For example, a least granule number can be resolved from an input channel. Each input channel can be examined to determine the final tuple associated with a granule is available for processing. For example, a granule table can be used with an entry for each input channel and current granule of each input channel can be monitored. The resolved input can be determined based on comparing the current granule of each input channel. For example, the least granule can be resolved from an input channel based on the current granule of the other input channels.

At blocks 804, 814, and 822, the scope of the resolved granule can be determined. For example at block 804, granule-level processing can occur if the scope of the resolved tuples is a granule. Similarly, if the scope of the resolved tuples is a slide or window, then the appropriate level of processing can occur at the appropriate blocks, such as at blocks 814 and 822 respectively. FIG. 8 shows an example method of checking the scope for granule processing at block 804, then for sliding processing at 816 and window (or slide, if the window is equal to the slide) at block 826.

If the processing scope is a granule, the granule boundary can be checked at block 806. If the resolved granule is beyond the current granule, than a granule result can be summarized at block 808. At block 810, the granule result buffer can be shifted. The result buffer can include the results of the data stream processing. The held tuples can be processed at block 812 according to granule level processing. For example, the granule level processing can be specified by the application logic.

If the processing scope is not for a granule or if the resolved granule is not beyond the current granule, the slide boundary can be checked at block 814. If the resolved granule is beyond the current slide, the processing scope can be checked. If the scope is for a window, then the window boundary can be checked at block 822. If the processing scope is for a slide, then a slide result can be summarized at block 818 and slide result buffer can be shifted at block 820. For example, a first window can be partially processed based on a punctuation of a set of held tuples, assuming the set of held tuples achieve the slide size and the slide size is less than a window size

The window boundary is checked at block 822. If the resolved granule is beyond the current window then the window result can be summarized at block 824. For example, a first window can be processed when a first window boundary is achieved and a slide boundary is achieved. If the scope of the processing is for a window, then the held tuples can be processed at a window-level processing at block 828.

At block 830, the resolved tuple can be held or processed based on the blocks of FIG. 8. Based on the application logic, if the resolved tuples fit in the processing scope determined by the application logic, then the held tuples are processed. For example, if the dynamic behavior of the application logic fits the scope of the set of held tuples, then the dynamic behavior can be used to process the set of held tuples according to analysis-specific details provided by the application logic. If the resolved tuples do not fit in the processing scope based on the application logic, then the resolved tuple can be held. For example, the tuple can be held when a slide operation does not advance or when the current input is larger than a resolved input. The result buffers can be maintained and used to combine the results. For example, the result buffers can be combined based on the application logic to discover patterns of the data stream.

Although the flow diagrams of FIGS. 4-8 illustrate specific orders of execution, the order of execution can differ from that which is illustrated. For example, the order of execution of the blocks can be scrambled relative to the order shown. Also, the blocks shown in succession can be executed concurrently or with partial concurrence. All such variations are within the scope of the present invention.

The present description has been shown and described with reference to the foregoing examples. It is understood, however, that other forms, details, and examples can be made without departing from the spirit and scope of the invention that is defined in the following claims.

What is claimed is:

1. A system for processing a data stream comprising:
a station engine to provide a stream operator to:
receive application logic for sliding window processing;
punctuate the data stream based on a boundary parameter; and
determine a number of input channels for parallel processing;
an execution engine to perform a behavior of the application logic during a process operation; and
a synchronize engine to hold data of the data stream associated with a window until each input channel has reached a data boundary based on the boundary parameter.

2. The system of claim 1, wherein the execution engine is to:
perform the behavior of the application logic based on a plurality of boundary parameters, wherein the plurality of boundary parameters comprises:
a granule size to be a range of tuples;
a slide size to be a first range of granules; and
a window size to be a second range of granules.

3. The system of claim 2, wherein, based on the data boundary, the behavior is to summarize one of a window, a slide, and a granule in accordance with the application logic.

4. The system of claim 1, comprising:
a spout engine to generate tuples with a granule field;
the synchronize engine to maintain a granule table to contain a current granule number of each input channel.

5. The system of claim 4, comprising:
a combine engine to combine the output of a set of summaries based on the conclusion of the window, the conclusion based on the granule table.

6. A machine readable storage medium comprising a set of instructions executable by a processor resource to:
execute a template behavior to initialize parallel processing of a data stream;
execute a dynamic behavior based on a boundary parameter and application logic for sliding window processing,
hold a tuple of the data stream when a granule number of the current input is larger than a resolved granule number; and
a process the held tuple of a first window based on the application logic when a second window boundary is achieved.

7. The medium of claim 6, wherein the set of instructions is to:
receive the application logic to specify processing details of a template logic.

8. The medium of claim 6, wherein the set of instructions is to:
partially process the first window based on a punctuation of a set of held tuples, the set of held tuples being less than a window size.

9. The medium of claim 6, wherein the set of instructions is to:
process the first window when a first window boundary is achieved and a slide boundary is achieved.

10. The medium of claim 6, wherein the set of instructions is to:
resolve a least granule number from an input channel; and
hold the tuple when a slide operation does not advance.

11. A method for processing a data stream comprising:
receiving boundary parameters including a granule size to be a range of tuples, a slide size to be a number of granules, and a window size to be a number of granules;
invoking application logic to process the data stream based on a sliding window technique, the application logic to be plugged into template logic;
receiving input from one of a plurality of channels, the data stream to be a processed by the plurality of channels based on the application logic;
holding a tuple when a current input is larger than a resolved input; and
processing a tuple when a punctuation boundary is achieved.

12. The method of claim 11, comprising:
determining a level of processing based on a set of held tuples, the boundary parameters, and the application logic.

13. The method of claim 12, wherein the level of processing is a partial window processing when the set of held tuples is less than the window size.

14. The method of claim 13, wherein the level of processing is a slide summarization when the set of held tuples achieves a slide boundary.

15. The method of claim 13, wherein the level of processing is a granule summarization when the set of held tuples achieves a granule boundary.
